(19) United States
(12) Patent Application Publication
(10) Pub. No.: US 2026/0326591 A1
(43) Pub. Date: Oct. 22, 2026

(54) PLUG IN HYBRID ELECTRIC VEHICLE VEHICLE-TO-EVERYTHING ARCHITECTURE

(71) Applicant: GM Global Technology Operations LLC, Detroit, MI (US)

(72) Inventors: Lei Hao, Shelby Township, MI (US); Dongxu Li, Troy, MI (US); Minh-Khai Nguyen, Troy, MI (US); Yilun Luo, Ann Arbor, MI (US); Samantha Gunter Miller, Berkley, MI (US)

(21) Appl. No.: 19/185,546

(22) Filed: Apr. 22, 2025

(51) Int. Cl. B60L 53/22

(52) U.S. Cl. CPC B60L 53/22; B60L 2210/30

(57) ABSTRACT

A system for an electric vehicle. The system includes an alternating current (AC) power source, a direct current (DC) power source, a DC-AC converter having an output coupled to an AC power outlet of the vehicle, an inverter for converting the AC power at the AC power source to a direct current (DC) power, an isolated DC-DC converter of an onboard charging module that is coupled to a DC side of the DC-AC converter, a first set of contactors for connecting the inverter to the DC side of the DC-AC converter, a second set of contactors for connecting the DC power source to the isolated DC-DC converter, and a controller that configures the first set of contactors and the second set of contactors to select between using the AC power source and the DC power source to provide AC power to the AC power outlet.

### INTRODUCTION

The subject disclosure relates to vehicle-to-everything (V2X) operation of an electric vehicle and, in particular, to a method for providing power to outside loads from various power sources of the vehicle.

Electric vehicles can have multiple sources of electric power. An alternating current (AC) power source, such as an electrical machine, can be used to power motion of the vehicle. A direct current (DC) power source, such as a battery, can also be used. One feature of the electric vehicle is the ability to provide power to external loads, known as vehicle-to-everything (V2X) power distribution. However, there is no ability to select power sources. Accordingly, it is desirable to provide an architecture of an electrical system that allow for selecting a power source of the vehicle for external power distribution.

### SUMMARY

In one exemplary embodiment, a method of providing alternating current (AC) power from a vehicle is disclosed. The method includes determining an operating mode of the vehicle to be one of a drive mode and a stationary mode and operating an electrical system of the vehicle based on the operating mode. The electrical system includes an alternating current (AC) power source, a direct current (DC) power source, a DC-AC converter having an output coupled to an AC power outlet of the vehicle, an inverter for converting the AC power at the AC power source to a direct current (DC) power, an isolated DC-DC converter of an onboard charging module (OBCM) , the isolated DC-DC converter coupled to a DC side of the DC-AC converter, a first set of contactors for connecting the inverter to the DC side of the DC-AC converter, and a second set of contactors for connecting the DC power source to the isolated DC-DC converter. Operating the electrical system includes controlling a configuration of the first set of contactors and the second set of contactors to select between using the AC power source and the DC power source to provide AC power to the AC power outlet based on the operating mode.

In addition to one or more of the features described herein, the AC power source is one of an engine, generator, or electrical machine of the vehicle and the DC power source is a battery of the vehicle.

In addition to one or more of the features described herein, the OBCM includes a power factor correction AC-DC converter having an AC side coupled to an external power source, the power factor correction AC-DC converter electrically connected to the isolated DC-DC converter.

In addition to one or more of the features described herein, the method further includes performing one of closing the first set of contactors and opening the second set of contactors to select the AC power source and opening the first set of contactors and closing the second set of contactors to select the DC power source.

In addition to one or more of the features described herein, the method further includes controlling the configuration of the first set of contactors and the second set of contactors to provide a DC power to an auxiliary DC load via an auxiliary DC-DC converter.

In addition to one or more of the features described herein, the method further includes controlling the configuration of the first set of contactors and the second set of contactors to provide DC power to a direct DC load.

In addition to one or more of the features described herein, the DC-AC converter is one of a two-phase converter and a three-phase converter.

In another exemplary embodiment, an electrical system for an electric vehicle is disclosed. The electrical system includes an alternating current (AC) power source, a direct current (DC) power source, a DC-AC converter having an output coupled to an AC power outlet of the electric vehicle, an inverter for converting the AC power at the AC power source to a direct current (DC) power, an isolated DC-DC converter of an onboard charging module (OBCM) , the isolated DC-DC converter coupled to a DC side of the DC-AC converter, a first set of contactors for connecting the inverter to the DC side of the DC-AC converter, a second set of contactors for connecting the DC power source to the isolated DC-DC converter, and a controller for controlling a configuration of the first set of contactors and the second set of contactors to select between using the AC power source and the DC power source to provide AC power to the AC power outlet based on a drive mode of the electric vehicle.

In addition to one or more of the features described herein, the AC power source is one of an engine, generator, or electrical machine of the electric vehicle and the DC power source is a battery of the electric vehicle.

In addition to one or more of the features described herein, the OBCM includes a power factor correction AC-DC converter having an AC side coupled to an external power source, the power factor correction AC-DC converter electrically connected to the isolated DC-DC converter.

In addition to one or more of the features described herein, the controller is configured to one of close the first set of contactors and open the second set of contactors to select the AC power source and open the first set of contactors and close the second set of contactors to select the DC power source.

In addition to one or more of the features described herein, the electrical system further includes an auxiliary DC-DC converter selectively connected to the AC power source and the DC power source via the first set of contactors and the second set of contactors to provide a DC power to an auxiliary DC load.

In addition to one or more of the features described herein, the electrical system further includes a direct DC load selectively connected to the AC power source and the DC power source via the first set of contactors and the second set of contactors.

In addition to one or more of the features described herein, the DC-AC converter is one of a two-phase converter and a three-phase converter.

In yet another exemplary embodiment, a vehicle is disclosed. The vehicle includes an alternating current (AC) power outlet, an AC power source, a direct current (DC) power source, a DC-AC converter having an output coupled to the AC power outlet of the vehicle, an inverter for converting the AC power at the AC power source to a direct current (DC) power, an isolated DC-DC converter of an onboard charging module (OBCM) , the isolated DC-DC converter coupled to a DC side of the DC-AC converter, a first set of contactors for connecting the inverter to the DC side of the DC-AC converter, a second set of contactors for connecting the DC power source to the isolated DC-DC converter, and a controller for controlling a configuration of the first set of contactors and the second set of contactors to select between using the AC power source and the DC power source to provide AC power to the AC power outlet based on a drive mode of the vehicle.

In addition to one or more of the features described herein, the AC power source is one of an engine, generator, or electrical machine of the vehicle and the DC power source is a battery of the vehicle.

In addition to one or more of the features described herein, the OBCM includes a power factor correction AC-DC converter having an AC side coupled to an external power source, the power factor correction AC-DC converter electrically connected to the isolated DC-DC converter.

In addition to one or more of the features described herein, the controller is configured to one of close the first set of contactors and open the second set of contactors to select the AC power source and open the first set of contactors and close the second set of contactors to select the DC power source.

In addition to one or more of the features described herein, the vehicle further includes an auxiliary DC-DC converter selectively connected to the AC power source and the DC power source via the first set of contactors and the second set of contactors to provide a DC power to an auxiliary DC load.

In addition to one or more of the features described herein, the vehicle further includes a direct DC load selectively connected to the AC power source and the DC power source via the first set of contactors and the second set of contactors.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle, in accordance with an exemplary embodiment;

FIG. 2 shows a circuit diagram of an electrical system of the electric vehicle of FIG. 1;

FIG. 3 is a diagram illustrating power flow through the electric system of FIG. 2, in an embodiment;

FIG. 4 shows a circuit diagram of the electric system in another embodiment; and

FIG. 5 is a flowchart of a method for operating the electrical systems of FIGS. 2-4, in an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

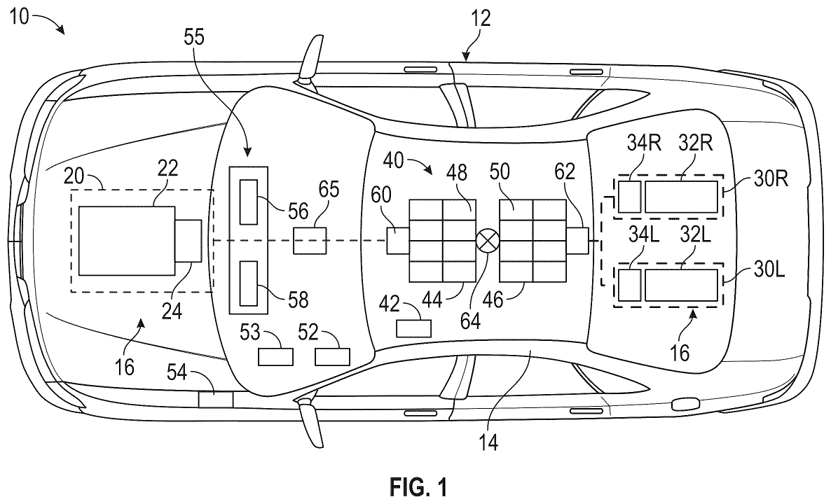

In accordance with an exemplary embodiment, FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

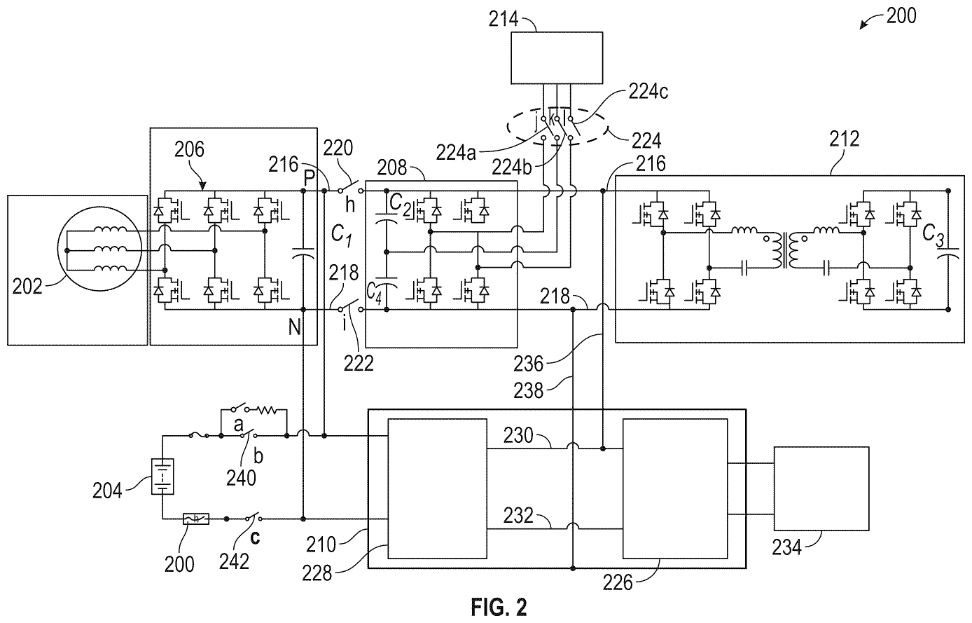

FIG. 2 shows a circuit diagram 200 of an electrical system of the electric vehicle of FIG. 1. The electrical system includes an alternating current power source (AC power source 202), such as an electrical motor of the vehicle or generator of the vehicle driven by engine or fuel cell, and a direct current power source (DC power source 204), such as a battery of the vehicle. Output of the AC power source 202 is connected to an inverter 206. The electrical system further includes a DC-AC converter (split-phase inverter 208), a bi-directional onboard charging module (OBCM 210) and an auxiliary DC-DC converter 212. An output of the split-phase inverter 208 is connected to an AC power outlet 214.

The AC power source 202 outputs an AC power and the DC power source 204 outputs a DC power. An output of the AC power source 202 is coupled to the inverter 206, which converts the AC power to a DC power. The DC power transmitted along a positive voltage bus 216 and a negative voltage bus 218. The positive voltage bus 216 includes a first contactor 220 and the negative voltage bus 218 includes a second contactor 222. The first contactor 220 can be selectivity configured to connect the positive voltage bus 216 to a positive input of the split-phase inverter 208 as well as to a positive input of the auxiliary DC-DC converter 212. Similarly, the second contactor 222 can be selectivity configured to connect the negative voltage bus 218 to a negative input of the split-phase inverter 208 as well as to the negative input of the auxiliary DC-DC converter 212. The first contactor 220 and the second contactor 222 form a first set of contactors.

The OBCM 210 includes an AC-DC converter with power factor correction AC-DC converter (PFC AC-DC converter 226) and an isolated DC-DC converter 228. The PFC AC-DC converter 226 is electrically coupled to the isolated DC-DC converter 228 via a positive OBCM bus 230 and a negative OBCM bus 232. An AC side of the PFC AC-DC converter 226 can be coupled to an external power source, such as a home charging station, at AC charging inlet 234. A positive connector line 236 connects the positive OBCM bus 230 to the positive voltage bus 216 on a converter side of the first contactor 220. A negative connector line 238 connects the negative OBCM bus 232 to the negative voltage bus 218 on the converter side of the second contactor 222.

The DC power source 204 has a positive terminal and a negative terminal. A third contactor 240 can be selectively configured to connect positive terminal to the isolated DC-DC converter 228 and to the positive voltage bus 216 on the inverter side of first contactor 220. A fourth contactor 242 can be selectively configured to connect the negative terminal to the isolated DC-DC converter 228 and to the negative voltage bus 218 on the inverter side of second contactor 222. The third contactor 240 and the fourth contactor 242 form a second set of contactors.

The split-phase inverter 208 converts the DC power along the positive voltage bus 216 and the negative voltage bus 218 to AC power that can be provided to the AC power outlet 214. The split-phase inverter 208 includes two phase legs and a capacitor leg. Each phase leg has a pair of switches in series between the positive voltage bus 216 and the negative voltage bus 218. Each switch includes a transistor with a diode across it. A first phase leg draws a voltage from a midpoint between a first pair of switches and a second phase leg draws a voltage from a midpoint between a second pair of switches. The capacitor leg includes two capacitors and a third phase leg draws a voltage from a midpoint between the capacitors. Thus, the phase legs are electrically connected to the AC power outlet 214 via a third set of contactors 224 including contactors 224a-c. A balancing circuit (not shown) is connected with capacitors C2 and C4 can balance the voltage between capacitors C2 and C4 to ensure that each capacitor shares the same voltage. As a result, the mid-point of these capacitors can be used as the neutral point of split-phase inverter 208.

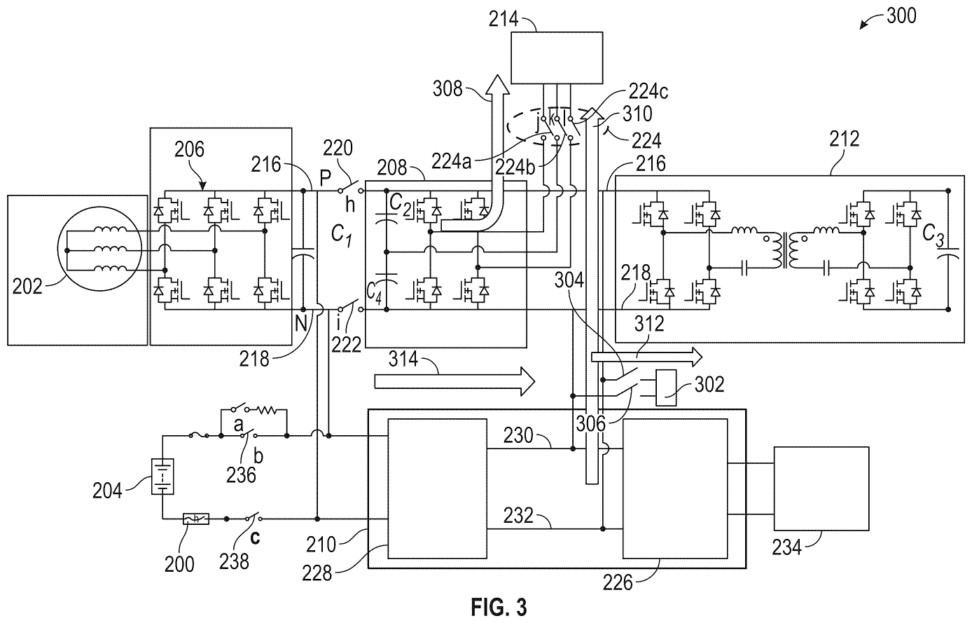

FIG. 3 is a diagram 300 illustrating power flow through the electric system of FIG. 2, in an embodiment. The electric system includes a direct DC load 302 that is coupled to the positive connector line 236 via a fifth contactor 304 and the negative connector line 238 via a sixth contactor 306. The fifth contactor 304 and the sixth contactor 306 form a fourth set of contactors.

A first arrow 308 shows a flow of power from the AC power source 202. The first arrow 308 flows when the first set of contactors are closed and the second set of contactors are open. The power flows from the AC power source 202 through the inverter 206 and the split-phase inverter 208 to the AC power outlet 214. The third set of contactors 224 are closed to allow AC power to the AC power outlet 214. The fourth set of contactors are open.

A second arrow 310 shows a flow of power from the DC power source 204. The second arrow 310 flows when the first set of contactors are open and the second set of contactors closed. The power flow from the DC power source 204 through the isolated DC-DC converter 228 and the split-phase inverter 208 to the AC power outlet 214. The third set of contactors 224 are closed to allow AC power to the AC power outlet 214. The fourth set of contactors are open.

With the first set of contactors and the fourth set of contactors closed and the second set of contactors and the third set of contactors open, the AC power source 202 can be used to provide DC power to the direct DC load 302, as shown by third arrow 312.

With the first set of contactors, the second set of contactors, the third set of contactors open and the fourth set of contactors is closed, the AC power source 202 can provide DC power to the direct DC load 302 via the isolated DC-DC converter 228, and also can simultaneously provide AC power to the external power source at the AC charging inlet 234 via isolated DC-DC converter 228 and PFC AC-DC converter 226, as shown by fourth arrow 314.

With the first set of contactors closed and the second set of contactors, the third set of contactors and the fourth set of contactors is open, the AC power source 202 can provide DC power to an auxiliary DC load via auxiliary DC-DC converter 212.

With the first set of contactors and the third set of contactors open, and the second set of contactors and the fourth set of contactors closed, the DC power source can provide DC power to the direct DC load 302, as shown by third arrow 312.

With the first set of switches open, the second set of contactors and the fourth set of switches open and the second set of switches closed. The DC power source can provide DC power to an auxiliary load via the auxiliary DC-DC converter 212.

With the first set of switches, the second set of switches and the fourth set of switches open and the third set of switches closed, AC power can be provided from the external power source at the AC charging inlet 234 to the AC power outlet 214.

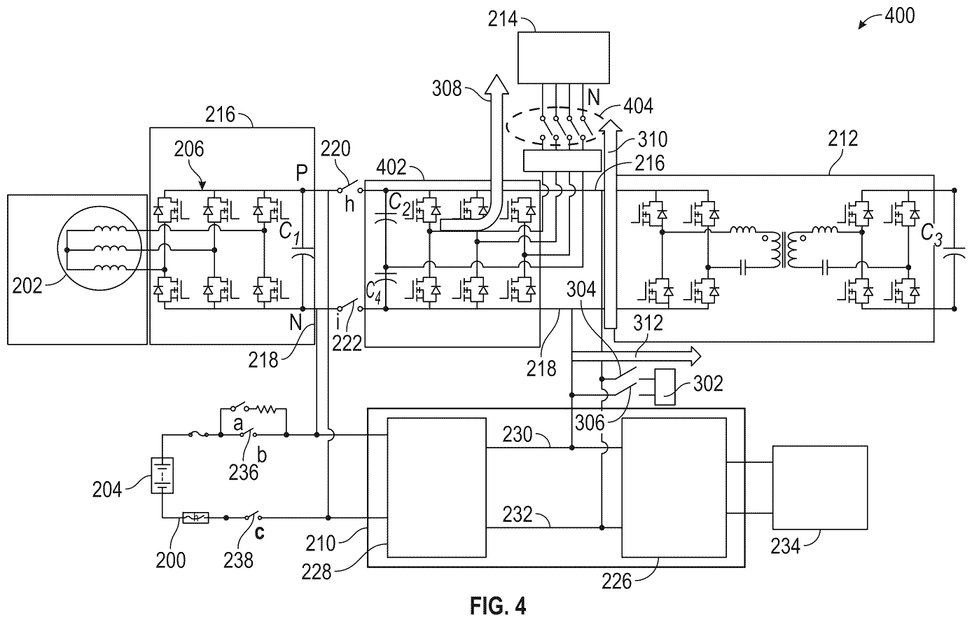

FIG. 4 shows a circuit diagram 400 of the electric system in another embodiment. The electric system includes the components of the electric system of FIG. 2 except that a DC-AC converter 402 (replacing the split-phase inverter 208 of FIGS. 2 and 3) is a three-phase converter. DC-AC converter 402 includes four phase lines. Three of the phase lines are connected to the three legs, respectively, of the DC-AC converter 402. A fourth phase line is connected to a midpoint voltage between the positive voltage bus 216 and the negative voltage bus 218. Contactors 404 can be closed independently to provide AC power from the DC-AC converter 402 to the AC power outlet 214.

In an embodiment, two of the phase lines connected to the legs of the DC-AC converter 402 can be disconnected from the AC power outlet 214 by opening their respective contactors 404, while the phase line of the remaining leg is connected by closing its contactor. For the connected phase line, the upper and lower switches of its leg of the DC-AC inverter opened and its contactor is closed. Thus, two phase lines are connected to the AC power outlet 214, effectively turning it into DC outlet.

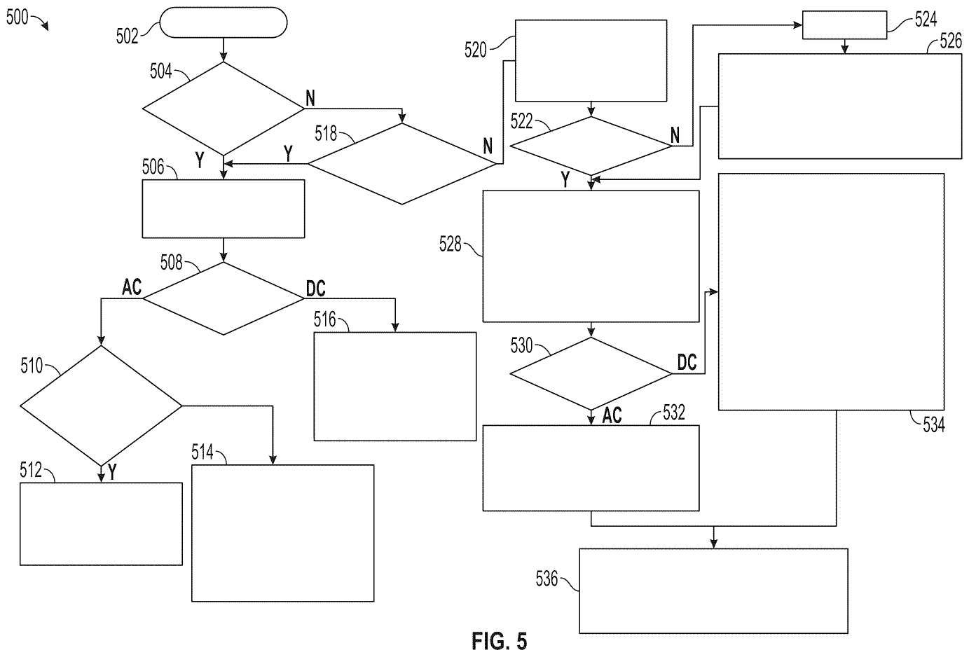

FIG. 5 is a flowchart 500 of a method for operating the electrical systems of FIGS. 2-4, in an embodiment. The method begins at box 502 as the vehicle enters a vehicle-to-everything (V2X) mode. In box 504, the controller determines the operation mode of the vehicle (i.e., drive mode or stationary mode). If the vehicle is in drive mode, the method proceeds to box 506. In box 506, the contactors are configured for V2X operation using the drive mode. The drive mode configuration includes opening the first set of contactors (i.e., first contactor 220 and second contactor 222) and closing the second set of contactors (i.e., third contactor 240 and fourth contactor 242). As a result of this contactor configuration, the AC power source 202 is disconnected from the electrical system and the DC power source 204 is included in the electrical system.

In box 508, the controller determines whether an AC load or a DC load is connected. If an AC load is connected, the method proceeds to box 510. Otherwise (DC load), the method proceeds to box 516.

In box 510, the magnitude of the AC load is compared to a power of the external power source at AC charging inlet 234. If the AC load matches the power of the external power source, the method proceeds to box 512. In box 512, power is provided from the AC charging inlet 234 to the AC power outlet 214. Power flows through the PFC AC-DC converter 226 of the OBCM 210 and to the split-phase inverter 208 (or DC-AC converter 402) and then to the AC power outlet 214. Returning to box 510, if the AC load does not match the power of the external power source at the AC charging inlet 234, the method proceeds to box 514. In box 514, power is provided from the DC power source 204 to the AC power outlet via the isolated DC-DC converter 228 and the split-phase inverter 208 (or DC-AC converter 402) to the AC power outlet 214. At the same time, power is also provided from the DC power source 204 via OBCM 210 to the AC charging inlet 234.

In box 508, if the load is a DC load, the method proceeds to box 516. In box 516, the DC power is provided from the DC power source 204 through the isolated DC-DC converter 228.

Returning to box 504, if the vehicle is not in drive mode, the method proceeds to box 518. In box 518, the controller checks to see if there is a need for the vehicle to be in drive mode. If so, the method proceeds to box 506 and the vehicle is placed in drive mode. Otherwise, the method proceeds to box 520. In box 520, the first set of contactors are closed and the second set of contactors are opened.

In box 522, the controller determines if the engine is on. If the engine is on, the method proceeds to box 528. Otherwise, the method proceeds to box 524. In box 524, the engine is started. In box 526, the engine is revved up slowly to pre-charge a DC link capacitor across the positive voltage bus 216 and the negative voltage bus 218 and to reach a desired speed according to engine efficiency and bus voltage specifications. From box 526, the method proceeds to box 528.

In box 528, the inverter 206 is operated to convert the AC power from the AC power source 202 to DC power. The inverter 206 can be operated in one of two ways: 1) by operating as a passive rectifier without implementing the transistors of the legs of the inverter; and 2) by active switching of the switches of the inverter using the transistor.

In box 530, the controller determines whether the load is an AC load or a DC load. If the load is an AC load, the method proceeds to box 532. If the load is a DC load, the method proceeds to box 534.

In box 532, the AC power is provided from the AC power source 202 via the inverter 206 and the split-phase inverter 208 to an AC load at the AC power outlet 214. AC power can also be provided (due to the DC power source 204) via the OBCM 210 to an AC load at the AC charging inlet 234. From box 532, the method proceeds to box 536.

In box 534, the power is provided from the AC power source 202 source to a DC load. The power can be provided several modes of operation. In one mode, the power is provided to the direct DC load 302 (without using the auxiliary DC-DC converter). In a second mode, the power is provided from the AC power source 202 to an auxiliary DC load using the auxiliary DC-DC converter 212. In a third mode, the power is provided from the AC power source 202 to the AC power outlet 214 using the split-phase inverter 208. Upper and lower switches turned on in separate legs of the inverter to provide DC power to the AC power outlet 214. From box 534, the method proceeds to box 536.

In box 536, the AC power source 202 is regulated to a desired speed that generates AC power to meet load and efficiency requirements.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

1. A method of providing alternating current (AC) power from a vehicle, comprising:
determining an operating mode of the vehicle to be one of a drive mode and a stationary mode;
operating an electrical system of the vehicle based on the operating mode, the electrical system comprising:
an alternating current (AC) power source;
a direct current (DC) power source;
a DC-AC converter having an output coupled to an AC power outlet of the vehicle;
an inverter for converting the AC power at the AC power source to a direct current (DC) power;
an isolated DC-DC converter of an onboard charging module (OBCM), the isolated DC-DC converter coupled to a DC side of the DC-AC converter;
a power factor correction AC-DC converter having an AC side electrically coupled to an external power source and a DC side electrically coupled to the isolated DC-DC converter and to input of the DC-AC converter;
a first set of contactors for connecting the inverter to the DC side of the DC-AC converter; and
a second set of contactors for connecting the DC power source to the isolated DC-DC converter;
wherein operating the electrical system comprises controlling a configuration of the first set of contactors and the second set of contactors to select between using the AC power source and the DC power source to provide AC power to the AC power outlet based on the operating mode.

2. The method of claim 1, wherein the AC power source is one of a generator and an electrical machine of the vehicle and the DC power source is a battery of the vehicle.

3. The method of claim 1, further comprising coupling a direct DC load to the DC side of the power factor correction AC-DC converter.

4. The method of claim 1, further comprising performing one of: (i) closing the first set of contactors and opening the second set of contactors to connect the AC power source to the DC/AC converter via the inverter; and (ii) opening the first set of contactors and closing the second set of contactors to select the DC power source which generates a DC power that flows through the isolated DC-DC converter, the DC/AC converter and the power outlet.

5. The method of claim 1, further comprising controlling the configuration of the first set of contactors and the second set of contactors to provide a DC power to an auxiliary DC load via an auxiliary DC-DC converter.

6. The method of claim 1, further comprising controlling the configuration of the first set of contactors and the second set of contactors to provide DC power to a direct DC load.

7. The method of claim 1, wherein the DC-AC converter is one of a two-phase converter and a three-phase converter.

8. An electrical system for an electric vehicle, comprising:
an alternating current (AC) power source;
a direct current (DC) power source;
a DC-AC converter having an output coupled to an AC power outlet of the electric vehicle;
an inverter for converting the AC power at the AC power source to a direct current (DC) power;
an isolated DC-DC converter of an onboard charging module (OBCM), the isolated DC-DC converter coupled to a DC side of the DC-AC converter;
a power factor correction AC-DC converter having an AC side electrically coupled to an external power source and a DC side electrically coupled to the isolated DC-DC converter and to input of the DC-AC converter;
a first set of contactors for connecting the inverter to the DC side of the DC-AC converter;
a second set of contactors for connecting the DC power source to the isolated DC-DC converter; and
a controller for controlling a configuration of the first set of contactors and the second set of contactors to select between using the AC power source and the DC power source to provide AC power to the AC power outlet based on a drive mode of the electric vehicle.

9. The electrical system of claim 8, wherein the AC power source is one of a generator and an electrical machine of the electric vehicle and the DC power source is a battery of the electric vehicle.

10. The electrical system of claim 8, further comprising a direct DC load coupled to the DC side of the power factor correction AC-DC converter.

11. The electrical system of claim 8, wherein the controller is configured to one of: (i) close the first set of contactors and open the second set of contactors to connect the AC power source to the DC/AC converter via the inverter; and (ii) open the first set of contactors and close the second set of contactors to select the DC power source which generates a DC power that flows through the isolated DC-DC converter, the DC/AC converter and the power outlet.

12. The electrical system of claim 8, further comprising an auxiliary DC-DC converter selectively connected to the AC power source and the DC power source via the first set of contactors and the second set of contactors to provide a DC power to an auxiliary DC load.

13. The electrical system of claim 8, further comprising a direct DC load selectively connected to the AC power source and the DC power source via the first set of contactors and the second set of contactors.

14. The electrical system of claim 8, wherein the DC-AC converter is one of a two-phase converter and a three-phase converter.

15. A vehicle, comprising:
an alternating current (AC) power outlet;
an AC power source;
a direct current (DC) power source;
a DC-AC converter having an output coupled to the AC power outlet of the vehicle;
an inverter for converting the AC power at the AC power source to a direct current (DC) power;
an isolated DC-DC converter of an onboard charging module (OBCM), the isolated DC-DC converter coupled to a DC side of the DC-AC converter;
a power factor correction AC-DC converter having an AC side electrically coupled to an external power source and a DC side electrically coupled to the isolated DC-DC converter and to input of the DC-AC converter;
a first set of contactors for connecting the inverter to the DC side of the DC-AC converter;
a second set of contactors for connecting the DC power source to the isolated DC-DC converter; and
a controller for controlling a configuration of the first set of contactors and the second set of contactors to select between using the AC power source and the DC power source to provide AC power to the AC power outlet based on a drive mode of the vehicle.

16. The vehicle of claim 15, wherein the AC power source is one of a generator and an electrical machine of the vehicle and the DC power source is a battery of the vehicle.

17. The vehicle of claim 15, further comprising a direct DC load coupled to the DC side of the power factor correction AC-DC converter.

18. The vehicle of claim 15, wherein the controller is configured to one of: (i) close the first set of contactors and open the second set of contactors to connect the AC power source to the DC/AC converter via the inverter; and (ii) open the first set of contactors and close the second set of contactors to select the DC power source which generates a DC power that flows through the isolated DC-DC converter, the DC/AC converter and the power outlet.

19. The vehicle of claim 15, further comprising an auxiliary DC-DC converter selectively connected to the AC power source and the DC power source via the first set of contactors and the second set of contactors to provide a DC power to an auxiliary DC load.

20. The vehicle of claim 15, further comprising a direct DC load selectively connected to the AC power source and the DC power source via the first set of contactors and the second set of contactors.
